(19) United States
(12) Patent Application Publication
(10) Pub. No.: US 2009/0167284 A1
(43) Pub. Date: Jul. 2, 2009

(54) MULTI-MAGNETIC DEVICE

(76) Inventor: Robert D. Wickersham, Roy, WA (US)

Correspondence Address: INTEL CORPORATION;c/o CPA Global, P.O. BOX 52050, MINNEAPOLIS, MN, 55402, US

(21) Appl. No.: 11/965,242

(22) Filed: Dec. 27, 2007

(51) Int. Cl. H01F 30/00; H01F 17/00

(52) U.S. Cl. 323/355; 336/105

(57) ABSTRACT

In some embodiments an inductor is external to a tightly coupled transformer. The inductor is coupled in series with at least one input of the tightly coupled transformer, and the inductor does not rely on any leakage inductances of the tightly coupled transformer. The tightly coupled transformer and the inductor are included in the same package. Other embodiments are described and claimed.

### TECHNICAL FIELD

The inventions generally relate to a multi-magnetic device.

### BACKGROUND

In an effort to provide higher efficiency in DC (Direct Current) to DC power conversion at a lower cost, many applications require utilizing magnetic devices that provide the equivalent of inductors in series with a tightly coupled transformer. These equivalent inductors are typically in series with the transformer in a manner that relies on leakage inductance associated with the inductances in series with the magnetizing inductance of the transformer. Providing the magnetics for this type of device requires the manufacturer to adjust the leakage inductance during the manufacturing process so that the inductances are appropriately provided in series with the transformer windings. It has been difficult for manufacturers to produce transformers with precise leakage inductance for the series inductors.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a circuit according to some embodiments of the inventions.

FIG. 2 illustrates a prior art device.

FIG. 3 illustrates a device according to some embodiments of the inventions.

### DETAILED DESCRIPTION

Some embodiments of the inventions relate to a multi-magnetic device.

In some embodiments an inductor is external to a tightly coupled transformer. The inductor is coupled in series with at least one input of the tightly coupled transformer, and the inductor does not rely on any leakage inductances of the tightly coupled transformer. The tightly coupled transformer and the inductor are included in the same package.

In some embodiments a power conversion circuit includes one or more switching devices (for example, one or more transistors) and a magnetic package. The magnetic package includes a tightly coupled transformer and an inductor that is external to the tightly coupled transformer. The inductor is coupled in series with at least one input of the tightly coupled transformer, and the inductor does not rely on any leakage inductances of the tightly coupled transformer. The tightly coupled transformer and the inductor are included in the same package.

In some embodiments a first magnetic device and a second magnetic device are integrated into one package and the second magnetic device is magnetically isolated from the first magnetic device. The tightly coupled transformer and the first inductor are included in the same package. In some embodiments the first magnetic device is a transformer and the second magnetic device is an inductor. In some embodiments each of the first and second magnetic devices is an inductor.

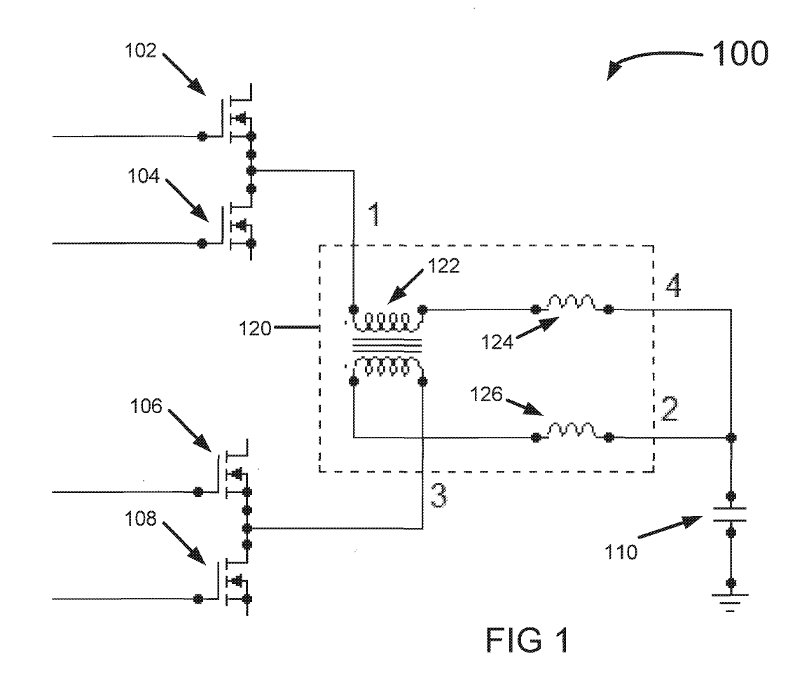

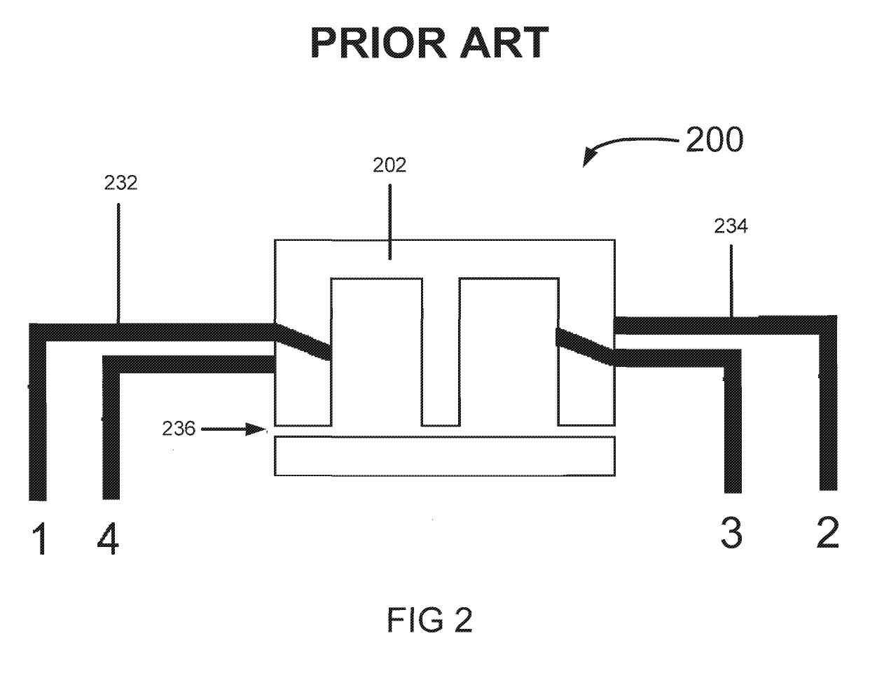

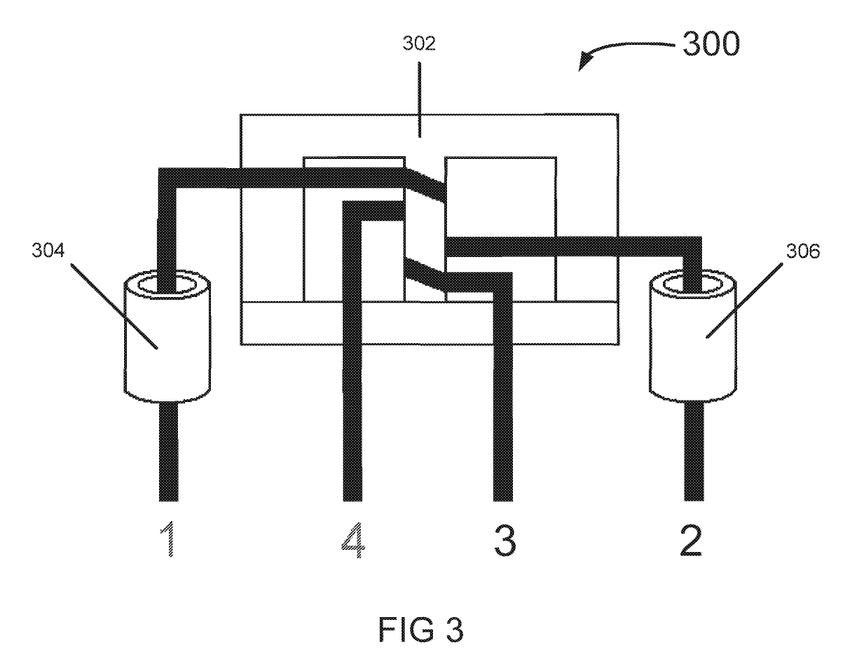

FIG. 1 illustrates a circuit 100 according to some embodiments. In some embodiments circuit 100 is a current doubler circuit. In some embodiments circuit 100 is a power conversion circuit. In some embodiments circuit 100 is a DC to DC power conversion circuit. In some embodiments circuit 100 is a voltage regulator. In some embodiments circuit 100 includes transistors 102, 104, 106 and 108. In some embodiments circuit 100 includes capacitor 110. In some embodiments circuit 100 includes magnetics 120, which are illustrated using a dotted line box 120 in FIG. 1. In some embodiments magnetics 120 includes a transformer 122, an inductor 124, and an inductor 126. In some embodiments the transformer 122 is an E core transformer. The magnetics 120 has four terminals numbered 1, 2, 3, and 4 in FIG. 1. In some embodiments the coupling of transformer 122 is connected so that the coupling from one winding of the transformer to the other is magnetically opposed. In some embodiments, the series inductances of inductors 124 and 126 are the inductances for the two phases. In some embodiments, due to the action of the transformer 122, most of the current from the active phase of the transformer is also injected into the other phase of the transformer. This improves both the efficiency and the performance of the circuit 100. Inductors 124 and 126 can be integrated into transformer 122 as leakage inductances of the transformer 122 (for example, in a manner similar to that depicted in FIG. 2). However, there are problems with this type of arrangement. In some embodiments, on the other hand, inductors 124 and 126 are two separate inductors in series with inputs of the transformer 122 (for example, in a manner similar to that depicted in FIG. 3).

FIG. 2 illustrates a prior art device 200. Device 200 includes a transformer 202. Transformer 202 is an E core transformer with a gap 236 located therein. Gap 236 provides leakage inductance of transformer 202. Transformer 202 has inductances integrated therein as leakage inductances.

Leakage inductances can be thought of as magnetic flux that does not get carried over to the other winding of the transformer (as opposed to magnetizing inductance which magnetizes the core and produces flux in the other winding). In transformers where windings are loosely coupled, some magnetic flux does not get coupled over to the other winding. In transformers where windings are tightly coupled, almost all magnetic flux does get coupled over to the other winding.

The leakage inductances of FIG. 2 are implemented by having the windings 232 and 234 go through a respective outer leg (or edge) of the transformer 202 to implement the leakage inductances. The windings 232 and 234 are each wound once around a respective edge of the transformer 202 to implement the leakage inductances. The leakage inductances are separate from the transformer's coupling or magnetizing inductance, and are a critical element of the circuit in which device 200 is included. However, the leakage inductances can be difficult to manufacture in a controlled manner to ensure that the correct value of leakage inductance is being produced.

FIG. 3 illustrates a device 300 according to some embodiments. In some embodiments device 300 is a transformer 302 and/or includes a transformer 302. In some embodiments transformer 302 is an E core transformer. In some embodiments device 300 includes an inductor 304 and an inductor 306. Terminals of both inductors 304 and 306 are wound around a middle leg (or middle section) of transformer 302. The two windings are on the same leg to provide tight coupling of the transformer. In some embodiments, each of the wires going through the cores of the inductors 304 and 306 are wound one turn around the middle leg (or middle section) of transformer 302 to provide tight coupling. That is, transformer 302 is a tightly coupled transformer (as opposed to a transformer that uses leakage inductance, for example). In some embodiments, inductor 304 and inductor 306 are in series with the inputs of the transformer 302 (for example, the inputs of the transformer 302 in FIG. 3 are numerals 2 and 4 in FIG. 3 and/or leads going from inductors 304 and 306 into the transformer 302). The separate inductors 304 and 306 along with a tightly coupled transformer 302 are provided in some embodiments. Instead of utilizing leakage inductance in a loosely coupled transformer, device 300 uses separate inductors 304 and 306 along with the tightly coupled transformer. In some embodiments external inductors, which are easier to manufacture than relying on leakage inductances, are provided in the same package as a tightly coupled transformer. That is, in some embodiments, inductors 304 and 306 are easier to manufacture than relying on leakage inductances, and are provided in the same package as tightly coupled transformer 302. In some embodiments three magnetic devices (for example, transformer 302, inductor 304, and inductor 306) are all provided in one package. Although transformer 302 and inductors 304 and 306 are illustrated in FIG. 3 in a particular manner, it is noted that in some embodiments these three elements are arranged in a much more compact form than that depicted in FIG. 3. Additionally, although three magnetic devices are illustrated in FIG. 3 in other embodiments other numbers of magnetic devices may be included (for example, in some embodiments only two magnetic devices are included and integrated in one package and in some embodiments four or more magnetic devices are included and integrated in one package).

It is noted that in some embodiments the wire that goes through the inductor core (for example, the core of inductors 304 and/or 306) proceeds into the core of the transformer (for example, transformer 302). In some embodiments, the inductor (for example, inductor 304 and/or 306) is not a magnetic part of the transformer (for example, transformer 302).

In some embodiments, the usage of a middle leg (and/or a middle section) of an E-core transformer or another transformer, for example, for the windings provides a maximum use of the core material. The location of the windings on the core determine the degree of coupling. Therefore, in some embodiments, the tight coupling is determined by the two windings being as close to the same winding path as possible.

In some embodiments, a single package is provided with separate inductors (for example, inductors 304 and 306) and a tightly coupled transformer (for example, transformer 302). Since it may be difficult for some manufacturers to produce transformers with precise leakage inductance for series inductance of a circuit, magnetics may be used that are easier to manufacture and that do not rely on leakage inductance. Easier manufacturing allows for a lower cost and a more precise component device. In some embodiments, a lower cost magnetic device is provided that does not rely on leakage inductance and that can be produced with less cost and with better accuracy.

In some embodiments, three magnetic devices are integrated into one package (for example, performing three different functions integrated in one package). In some embodiments, three inductors are integrated in one package (for example, a transformer and two inductors). In some embodiments, two inductors are magnetically separated from a transformer and the transformer and the two inductors are included in one package.

Some embodiments have been described herein as including two inductors (for example, inductors 304 and 306 of FIG. 3). However, it is noted that according to some embodiments any number of inductors may be included. For example, in FIG. 3 only one of the inductors 304 or 306 might be included. In some embodiments, more inductors might be included in FIG. 3 (for example, one or more additional inductors in series with each or both of inductors 304 and/or 306). In such embodiments some or all of the inductors (whatever number of them) may be included in one package with the transformer.

Some embodiments have been described herein as including an E core transformer. However, in some embodiments any core shape and topology may be used for the transformer (for example, in some embodiments for a tightly coupled transformer). In some embodiments, for example, an “air core” type of transformer (air core transformer) may be used for the transformer (for example, in some embodiments for a tightly coupled transformer). Further, in some embodiments any type of topology may be used for the inductors. For example, in some embodiments, an air core topology may be used for the transformer and/or for one or more of the inductors.

In some embodiments a tightly coupled transformer is utilized. It is recognized that this implies that the transformer has two or more windings that are tightly coupled in the same magnetic area (for example, so that flux from one winding goes almost completely into one or more of the other windings). This same magnetic area can be in some embodiments the same middle leg or area of the transformer (for example, as illustrated in FIG. 3) or any other leg or area of a tightly coupled transformer.

In some embodiments, a magnetic package is included in one circuit such as a power conversion circuit (for example, as illustrated in FIG. 1). However, it is noted that in some embodiments more than one magnetic package may be included in one circuit such as a power conversion circuit, for example.

In some embodiments a transformer and a number of inductors are included. However, in some embodiments the transformer is also referred to as an inductor. For example, in the embodiment of FIG. 3 the transformer and two inductors can also be referred to as three inductors. In some embodiments instead of using a transformer and one or more inductors, two or more inductors may be used (for example, an inductor may replace transformer 302 in FIG. 3).

In some embodiments one or more magnetic device and/or one or more magnetic package is included in a circuit. In some embodiments the circuit is, for example, a current doubler circuit, a power conversion circuit, a DC to DC power conversion circuit, and/or a voltage regulator. Additionally, in some embodiments the circuit is, for example, a circuit utilizes series inductances with a transformer and is referred to as a “series coupled circuit”. In some embodiments, any circuitry may be implemented that utilizes a series inductance with a transformer.

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a tightly coupled transformer;
a first inductor external to the tightly coupled transformer;
wherein the first inductor is coupled in series with at least one input of the tightly coupled transformer, and wherein the first inductor does not rely on any leakage inductances of the tightly coupled transformer, wherein the tightly coupled transformer and the first inductor are included in the same package.

2. The apparatus of claim 1, further comprising a second inductor external to the tightly coupled transformer, wherein the second inductor is coupled in series with at least one input of the tightly coupled transformer, and wherein the second inductor does not rely on any leakage inductances of the tightly coupled transformer. (NOTE TO BOB: the terminology of the second inductor is ok since we define a transformer a first inductor and a second inductor it is clear which we are referring to from a legal patent standpoint. Also, I have added clarifying language in the specification regarding the transformer being an inductor.

3. The apparatus of claim 2, wherein the tightly coupled transformer, the first inductor, and the second inductor are all included in the same package.

4. The apparatus of claim 1, further comprising a plurality of additional inductors external to the tightly coupled transformer, wherein each of the plurality of additional inductors is coupled in series with at least one input of the tightly coupled transformer, and wherein each of the plurality of additional inductors does not rely on any leakage inductances of the tightly coupled transformer.

5. The apparatus of claim 4, wherein the tightly coupled transformer, the first inductor, and the plurality of additional inductors are all included in the same package.

6. A power conversion circuit comprising:
one or more switching devices; and
a magnetic package coupled to the one or more switching devices, the magnetic device including a tightly coupled transformer and a first inductor external to the tightly coupled transformer, wherein the first inductor is coupled in series with at least one input of the tightly coupled transformer, and wherein the first inductor does not rely on any leakage inductances of the tightly coupled transformer, wherein the tightly coupled transformer and the first inductor are included in the magnetic package.

7. The power conversion circuit of claim 6, further comprising one or more additional magnetic packages each including a respective additional tightly coupled transformer and one or more inductors external to the respective additional tightly coupled transformer, wherein the one or more inductors are coupled in series with at least one input of the respective additional tightly coupled transformer, and wherein the one or more inductors do not rely on any leakage inductances of the respective additional tightly coupled transformer, wherein the respective additional tightly coupled transformer and the one or more inductors are included in the respective additional magnetic package.

8. The power conversion circuit of claim 6, further comprising a second inductor external to the tightly coupled transformer, wherein the second inductor is coupled in series with at least one input of the tightly coupled transformer, and wherein the second inductor does not rely on leakage inductances of the tightly coupled transformer.

9. The power conversion circuit of claim 8, wherein the tightly coupled transformer, the first inductor, and the second inductor are all included in the same package.

10. The power conversion circuit of claim 10, further comprising a plurality of additional inductors external to the tightly coupled transformer, wherein each of the plurality of additional inductors is coupled in series with at least one input of the tightly coupled transformer, and wherein each of the plurality of additional inductors does not rely on any leakage inductances of the tightly coupled transformer.

11. The power conversion circuit of claim 10, wherein the tightly coupled transformer, the first inductor, and the plurality of additional inductors are all included in the same package.

12. The power conversion circuit of claim 6, further comprising one or more capacitors coupled to the magnetic package.

13. The power conversion circuit of claim 6, wherein the power conversion circuit is a DC to DC power conversion circuit.

14. The power conversion circuit of claim 6, wherein the power conversion circuit is a current doubler circuit.

15. The power conversion circuit of claim 6, wherein the one or more switching devices includes one or more transistors.

16. An apparatus comprising:
a first magnetic device; and
a second magnetic device;
wherein the first magnetic device and the second magnetic device are integrated into one package and wherein the second magnetic device is magnetically isolated from the first magnetic device.

17. The apparatus of claim 16, wherein the first magnetic device is a transformer and the second magnetic device is an inductor.

18. The apparatus of claim 17, wherein the transformer is a tightly coupled transformer.

19. The apparatus of claim 16, wherein the first magnetic device is an inductor and the second magnetic device is an inductor.

20. The apparatus of claim 16, further comprising a third magnetic device, wherein the first magnetic device, the second magnetic device, and the third magnetic device are integrated into one package and wherein the third magnetic device is magnetically isolated from the first magnetic device.

21. The apparatus of claim 20, wherein the first magnetic device is a transformer, the second magnetic device is an inductor, and the third magnetic device is an inductor.

22. The apparatus of claim 21, wherein the transformer is a tightly coupled transformer.

23. The apparatus of claim 20, wherein the first magnetic device is an inductor, the second magnetic device is an inductor, and the third magnetic device is an inductor.

24. The apparatus of claim 16, further comprising a plurality of additional magnetic devices, wherein the first magnetic device, the second magnetic device, and the plurality of additional magnetic devices are integrated into one package, and wherein each of the plurality of additional magnetic devices is magnetically isolated from the first magnetic device.
